(19) United States
(12) Patent Application Publication
(10) Pub. No.: US 2013/0008876 A1
(43) Pub. Date: Jan. 10, 2013

(54) WELDING METHOD

(76) Inventor: Thomas Ammann, Munich (DE)

(21) Appl. No.: 13/347,952

(22) Filed: Jan. 11, 2012

(30) Foreign Application Priority Data
Jan. 31, 2011 (DE) 102011009827.5

(51) Int. Cl. B23K 35/22; B23K 9/173; B23K 9/167

(52) U.S. Cl. 219/75; 219/74

(57) ABSTRACT

In a Gas Tungsten Arc or Gas Metal Arc welding method for austenitic steel that does not contain Ti or Al in a respective quantity of more than about 0.2% by weight, a welding additive containing Ti and/or Al is used in conjunction with a welding gas that contains nitrogen.

### CROSS REFERENCE TO RELATED APPLICATIONS

This application claims priority from German Patent Application 10 2011 009 827.5, filed Jan. 31, 2011.

### BACKGROUND OF THE INVENTION

The invention relates to a GTA or GMA welding (Gas Tungsten Arc or Gas Metal Arc welding) method for austenitic steels that do not contain either Ti or Al as the alloying element in a respective quantity of more than about 0.2% by weight.

Austenitic steels with a relatively low nickel content, for example those referred to as 9% nickel steels, and the austenitic Fe/Ni36 (or Fe36Ni) alloy (iron with 36% nickel, also known as “Invar®” steel), are used in pipelines for transporting liquid gases because they are resistant to cold. This last steel has a further advantage in that it does not expand more than negligibly when it is heated or contract when it is cooled, which means that expansion bends in longer lines may be dispensed with. The composition of these steels is as follows (source: ThyssenKrupp)
Fe/Ni36 (in % by weight):
Ni: 35.0-37.0
Cr: 0.25
C: 0.15
Mn: 0.60
Si: 0.40
Co: 0.50
P: 0.025
S: 0.025
Fe: Remainder
9% Ni steel:
Ni: 8.8-10.0
C: <0.10
Mn: 0.30-0.80
Fe: Remainder

However, these materials have the unfortunate property of forming an extremely coarse-grained weld metal when they are used for welding, which seriously impairs its mechanical properties. In the case of Fe/Ni36 attempts were made to get round this problem by using specially modified welding additives, in which 2% Cr and 1% Ai were added to the alloy, for example. While this improved the mechanical properties, it worsened the expansion behaviour of the weld metal.

It was then found, surprisingly, that 9% steel and Fe/Ni36 steel for example, but also other steels containing very low quantities of Ti and/or Al, form excellent weld beads if the elements Ti and/or Al are mixed with the welding additive and the welding gas also contains nitrogen.

### SUMMARY OF THE INVENTION

Accordingly, the invention relates to a GTA or GMA welding method for austenitic steel that does not contain either Ti or Al as alloying elements in a respective quantity greater than about 0.2% by weight, characterized in that in the method a welding additive containing Ti and/or Al is used together with a welding gas containing nitrogen.

Ti and Al react readily with nitrogen to form nitrides and are added in the alloy in a respective quantity from about 0.1% to about 5%, preferably from about 0.5% to about 3%, more preferably from about 1 to about 2%. Preferably, only one of these elements it added to the alloy. Ti is particularly preferred.

Preferably, no other elements that are not contained in the austenitic weld metal are mixed with the welding additives, for example in the case of Fe/Ni36 steel no Cr is alloyed with the welding additive, because it is not present in Fe/Ni36 steel in a significant quantity. Mixing by additional alloying of Cr for example to the weld metal itself is to be considered more as a “last resort”, since the tendency to form coarse grains prevents the desired mechanical characteristic from being achieved.

In conventional welding methods, the composition of the welding additive is usually very similar to that of the weld metal.

### DETIALED DESCRIPTION OF THE INVENTION

Accordingly, one partial aspect of an embodiment of the present invention (besides the use of a welding gas that contains nitrogen) is the addition by alloying of Ti and/or Al, as the only element or elements that is/are not contained in the steel alloy itself, in all welding additives for steel alloys that do not themselves contain significant quantities of either Ti or Al.

Thus, a welding additive for Fe/N36 steel preferably comprises 36% Ni, remainder Fe, and Ti and/or Al as the only additional element(s).

The welding additives are added in the form of a welding wire in GMA welding. In GTA welding they are added as either a welding wire or rod.

The nitrogen content of the welding gas is general about 1% to about 15%, preferably about 3% to about 10%, and particularly about 5% to about 8%.

The other gases are selected from the welding gases that are usual for GTA or GMA welding, for example argon, helium, CO₂, O₂ and H₂. A preferred welding gas is for example CRONIGON Ni30 (Ar+5%He+5%N₂+550 ppm CO₂), which contains the quantities of nitrogen listed in the preceding.

The weld metal to be processes may be any austenitic steel that does not contain significant quantities of Ti and/or Al as defined in the preceding. Examples of such are Fe/Ni36 steel and 9% nickel steel.

Fe/Ni36 steel is particularly preferred.

Surprisingly, it was found that the presence of Ti and/or Al in the welding additive is sufficient in conjunction with the nitrogen-containing gas to yield a significant refinement of the grain in of the weld seam, which in turn improves the quality of the weld seam. In the case of Fe/Ni36 steel, this means that, unexpectedly, besides a good profile of mechanical properties it is also possible to obtain excellent expansion characteristic, such as is not the case with the previously known welding methods.

What we claim is:

1. A gas tungsten arc or gas metal arc welding method for austenitic steel that does not contain either Ti or Ai in a respective quantity greater than 0.2% by weight, characterized in that in the method a welding additive containing Ti and/or Al is used together with a welding gas containing nitrogen.

2. The gas tungsten arc or gas metal arc welding method as claimed in claim 1, characterized in that austenitic steel is selected from 9% nickel steel

3. The ,gas tungsten arc or gas metal arc welding method as claimed in claim 1, characterized in that austenitic steel is selected from Fe/Ni36 steel.

4. The gas tungsten arc or gas metal arc welding method as claimed in claim 1, characterized in that except for Ti and/or Al no element that is not present in the austenitic steel is alloyed in a significant quantity with the welding additive, which is otherwise of the same species.

5. The gas tungsten arc or gas metal arc welding method as claimed in claim 1, characterized in that the Ti and/or Al is present in a respective quantity from about 0.1% to about 5%.

6. The gas tungsten arc or gas metal arc welding method as claimed in claim 1, characterized in that the Ti and/or Al is present in a respective quantity from about 0.5% to about 3%.

7. The gas tungsten arc or gas metal arc welding method as claimed in claim 1, characterized in that the Ti and/or Al is present in a respective quantity from about 1 to about 2%.

8. The gas tungsten arc or gas metal arc welding method as claimed in claim 1, characterized in that the nitrogen in the welding gas is present in a quantity from about 1% to about 15%.

9. The gas tungsten arc or gas metal arc welding method as claimed in claim 1, characterized in that the nitrogen in the welding gas is present in a quantity from about 3% to about 10%.

10. The gas tungsten arc or gas metal arc welding method as claimed in claim 1, characterized in that the nitrogen in the welding gas is present in a quantity from about 5% to about 8%.

11. The gas tungsten arc or gas metal arc welding method as claimed in claim 1, characterized in that the remainder of the welding gas is selected from the group consisting of argon, helium, CO₂, O₂ and H₂.
